(19) United States
(12) Patent Application Publication
(10) Pub. No.: US 2019/0160920 A1
(43) Pub. Date: May 30, 2019

(54) LAMINATED GLASS

(71) Applicant: AGC INC., Chiyoda-ku (JP)

(72) Inventors: Seiichi MIYASAKA, Chiyoda-ku (JP); Yuhei Gima, Chiyoda-ku (JP); Tokihiko Aoki, Chiyoda-ku (JP)

(73) Assignee: AGC INC., Chiyoda-ku (JP)

(21) Appl. No.: 16/264,743

(22) Filed: Feb. 1, 2019

Related U.S. Application Data
(63) Continuation of application No. PCT/JP2017/023052, filed on Jun. 22, 2017.

(30) Foreign Application Priority Data
Aug. 12, 2016 (JP) 2016-158857

(51) Int. Cl. B60J 1/00; B32B 17/10; B60S 1/02; B60J 1/02; H05B 3/26; H05B 3/84

(52) U.S. Cl. CPC B60J 1/001; B32B 17/10559; B32B 17/10036; B32B 17/10385; B32B 2605/006; B60J 1/02; H05B 3/265; H05B 3/84; B60S 1/026

(57) ABSTRACT

A laminated glass includes a pair of glass plates opposite each other; a pair of intermediate bonding layers located between the pair of glass plates, each of the intermediate bonding layers contacting a corresponding glass plate of the glass plates; and a base film located between the pair of intermediate bonding layers, and being provided with a wiring in at least a partial area of the base film. A thickness of one of the intermediate bonding layers is thinner than a thickness of another one of the intermediate bonding layers. A thickness of a thinner intermediate bonding layer of the pair of intermediate bonding layers is 0.20 mm or less.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2017/023052 filed on Jun. 22, 2017 and designating the U.S., which is based on and claims priority to Japanese Patent Application No. 2016-158857 filed on Aug. 12, 2016. The entire contents of the foregoing applications are incorporated herein by reference.

### BACKGROUND OF THE INVENTION

### 1. Field of the Invention

The disclosure herein generally relates to a laminated glass.

### 2. Description of the Related Art

A laminated glass holding an electric heating wire in between (electric heating glass), used for a window glass of vehicles, such as a car or a train, for eliminating freezing of water adhering to the window glass in winter seasons (ice melting) or removing fogging on the window glass (defogging), is widely known.

The electric heating glass specifically includes, for example, a so-called heat wire (e.g. See Japanese Unexamined Patent Application Publication H08-072674), prepared by mainly adhering a thin metallic wire to an intermediate bonding layer in advance, or a laminated glass encapsulating a base film in which a conductive wiring is formed (e.g. See Japanese Unexamined Patent Application Publication 2016-020145).

In order to encapsulate the base film, in which a conductive wiring is formed, in a laminated glass, the base film is required to be held by two sheets of intermediate bonding layers in between so that the base film is bonded to glass plates on both sides of the base film.

### SUMMARY OF THE INVENTION

### Technical Problem

However, in the case of the configuration of encapsulating the base film in which a conductive wiring is formed, in the laminated glass, compared with the heat wire, a heat from the electric heating wire is not directly transferred to the glass plates, but transferred via the intermediate bonding layers.

Thus, there is a problem that a temperature of the intermediate bonding layer near the electric heating wire increases when current is applied, and an optical distortion due to a change in a refractive index of the intermediate bonding layer becomes remarkable.

The present invention was made in view of such a problem, and it is an object of the present invention to reduce an optical distortion when current is applied in a laminated glass encapsulating a base film, in which a conductive wiring is formed.

### Solution to Problem

According to an aspect of the present invention, a laminated glass includes

a pair of glass plates opposite each other;

a pair of intermediate bonding layers located between the pair of glass plates, each of the intermediate bonding layers contacting a corresponding glass plate of the glass plates; and

a base film located between the pair of intermediate bonding layers, and being provided with a wiring in at least a partial area of the base film,

a thickness of one of the intermediate bonding layers being thinner than a thickness of another one of the intermediate bonding layers, and

a thickness of a thinner intermediate bonding layer of the pair of intermediate bonding layers being 0.20 mm or less.

### Advantageous Effect of Invention

According to an aspect of the present invention, an optical distortion when current is applied in a laminated glass encapsulating a base film, in which a conductive wiring is formed, can be reduced.

### BRIEF DESCRIPTION OF THE DRAWINGS

Other objects and further features of embodiments will become apparent from the following detailed description when read in conjunction with the accompanying drawings, in which:

FIGS. 1A and 1B are diagrams depicting an example of a vehicle front windshield according to an embodiment.

### DETAILED DESCRIPTION OF THE PREFERRED EMBODIMENTS

In the following, with reference to drawings, embodiments of the present invention will be described. In each drawing, the same reference numeral is assigned to the same component, and redundant explanation will be omitted. In the following, a front windshield of a vehicle will be described as an example, but the present invention is not limited to this, and the laminated glass according to the embodiment can also be applied to other than the front windshield of the vehicle, such as a door glass or a rear glass. Moreover, the laminated glass according to the embodiment can be applied to a glass other than for vehicles.

[Front Windshield (Laminated Glass)]

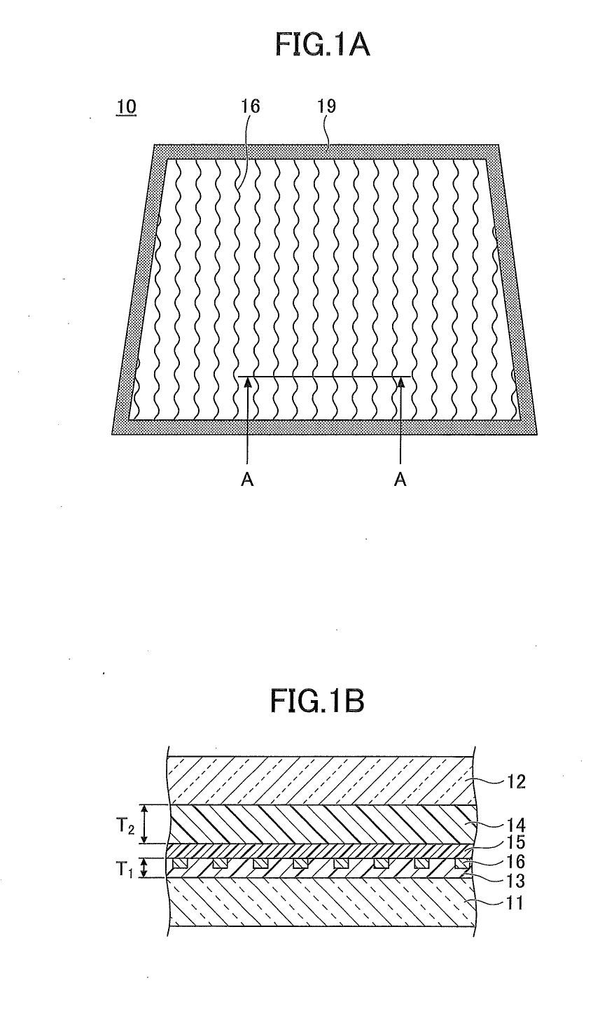

FIGS. 1A and 1B are diagrams depicting an example of a front windshield of a vehicle. FIG. 1A schematically illustrates a state of the front windshield viewed from the inside of the vehicle toward the outside of the vehicle. FIG. 1B is a cross-sectional view cut along a line A-A in FIG. 1A.

As illustrated in FIG. 1A, the front windshield 10 is a laminated glass including, as main configuration elements, a pair of glass plates 11 and 12, a pair of intermediate bonding layers 13 and 14, and a base film 15 in which a wiring 16 is formed. The front windshield 10 may or may not have a curved shape. A configuration where the pair of intermediate bonding layers 13 and 14 and the base film 15, in which a wiring is formed, are laminated will be referred also to as an intermediate film.

The glass plates 11 and 12 are arranged so as to face each other. For the glass plates 11 and 12, for example, a soda lime glass, an aluminosilicate glass, or an organic glass may be used. Thicknesses of the glass plates 11 and 12 may be properly determined taking into account various performances, such as a flying stone performance, or an easiness of shaping. For example, the thickness may fall within a range of about 0.3 mm to 3 mm.

Note that in order to perform an ice-melting or a defogging quickly, a thickness of at least any one of the glass plates 11 and 12 is preferably less than 1.8 mm. Particularly, in the case of using an electric heating glass according to the present invention for a vehicle window glass, in order to balance the flying stone performance with the fast ice-melting/defogging, the thickness of the glass plate of the vehicle exterior side is preferably 1.8 mm or more, and the thickness of the glass plate of the vehicle interior side is preferably less than 1.8 mm.

The intermediate bonding layers 13 and 14 bond the glass plate 11 and the glass plate 12 in a state where the base film 15, in which the wiring 16 is formed, is interposed between the intermediate bonding layers 13 and 14. The intermediate bonding layer 13 is arranged so as to contact the glass plate 11 and the base film 15 (on the side where the wiring 16 is formed), between the glass plate 11 and the glass plate 12, to coat the wiring 16. The intermediate bonding layer 14 is arranged so as to contact the glass plate 12 and the base film 15 (on the side where the wiring 16 is not formed), between the glass plate 11 and the glass plate 12.

For the intermediate bonding layers 13 and 14, a thermoplastic resin is often used. A thermoplastic resin that has been used conventionally for this kind of purpose includes, for example, a plasticized polyvinyl acetal resin, a plasticized polyvinyl chloride resin, a saturated polyester resin, a plasticized saturated polyester resin, a polyurethane resin, a plasticized polyurethane resin, an ethylene-vinyl acetate copolymer resin, or an ethylene-ethyl acrylate copolymer resin. Moreover, a resin composition including a modified block copolymer hydride disclosed in Japanese Unexamined Patent Application Publication 2015-000821 can be preferably used.

Among the aforementioned resins, a plasticized polyvinyl acetal resin is preferably used, because of its excellence in balance of performances, such as transparency, weather resistance, strength, bond strength, resistance to penetration, absorbability for impact energy, humidity resistance, thermal insulating property, and sound insulating property. The thermoplastic resin may be used singly, or two or more types of thermoplastic resins may be used in combination. The term “plasticized” in the plasticized polyvinyl acetal resin means that the resin is made mouldable by adding a plasticizing agent. The same applies to the other plasticized resins.

The polyvinyl acetal resin may include a polyvinyl formal resin that is obtained by reacting a polyvinyl alcohol (in the following, may be referred to as “PVA” as necessary) and a formaldehyde, a narrowly defined polyvinyl acetal resin that is obtained by reacting a PVA and an acetaldehyde, a polyvinyl butyral resin (in the following, may be referred to as “PVB” as necessary) that is obtained by reacting a PVA and a n-butyl aldehyde, and the like. Especially, a PVB is preferable, because of its excellence in balance of performances, such as transparency, weather resistance, strength, bond strength, resistance to penetration, absorbability for impact energy, humidity resistance, thermal insulating property, and sound insulating property. The polyvinyl acetal resin may be used singly, or two or more types of polyvinyl acetal resins may be used in combination. However, a material forming the intermediate bonding layers 13 and 14 is not limited to a thermoplastic resin.

The thickness of the intermediate bonding layer 13 and the thickness of the intermediate bonding layer 14 are different from each other. One of the thicknesses of the intermediate bonding layers 13 and 14 is preferably 0.01 mm or more and 0.20 mm or less. The other one of the thicknesses is not limited, but is preferably 0.38 mm or more and 2.28 mm or less from a viewpoint of giving a thermal insulating function, a sound insulating function or the like to the intermediate bonding layer. The thickness of the intermediate bonding layer arranged on the side contacting the wiring 16 (in the embodiment, the intermediate bonding layer 13) is preferably thinner than the thickness of the intermediate bonding layer arranged on the side not contacting the wiring 16 (in the embodiment, the intermediate bonding layer 14).

Because the thickness of one of the intermediate bonding layers is thinner than the thickness of the other one of the intermediate bonding layers, and the thickness of the thinner intermediate bonding layer is 0.20 mm or less, an optical distortion can be prevented effectively from occurring when current is applied for the wiring 16 (in the following, referred to as an optical distortion). The effect will be described later in detail with the practical examples.

In FIGS. 1A and 1B, as an example, the intermediate bonding layer 13 is thinner than the intermediate bonding layer 14. Thus, in this case, the thickness T₁ of the intermediate bonding layer 13 is preferably 0.01 mm or more and 0.20 mm or less. The thickness T₂ of the intermediate bonding layer 14 is not particularly limited, but is preferably 0.38 mm or more and 2.28 mm or less.

Note that at least one of the intermediate bonding layers 13 and 14 may partially contain a colorant including a dye or a pigment. A colored portion particularly functions as a belt-like shade region (shade band) with the color of green, blue or the like, in order to enhance an antiglare property, a heat insulating property or the like, in the case where the laminated glass according to the embodiment is used as a vehicle front windshield. The shade band is often arranged outside the visual field area, particularly in the upper part of the windshield. Alternatively, by containing a colorant including a dye or a pigment in the entire area of the intermediate bonding layer, a windshield that reduces glare of an external light can be obtained.

At least one of the intermediate bonding layers 13 and 14 may be used for a head-up display. In this case, at least one of the intermediate bonding layers 13 and 14 is designed to have cross sections with wedged shapes so that images projected from a projector and reflected at a front surface and at a back surface of the laminated glass are overlaid. That is, when the laminated glass is mounted on a vehicle, the intermediate film has a cross section with a wedged shape, in which a thickness increases upward from below.

Also in the case of such a laminated glass having a cross section with a wedged shape, within a region where a wiring is present, at any position from a lower end to an upper end of the region when the laminated glass is mounted on the vehicle, one of the thicknesses of the intermediate bonding layers 13 and 14 is preferably 0.01 mm or more and 0.20 mm or less. The other one of the thicknesses is not limited, but is preferably 0.38 mm or more and 2.28 mm or less from a viewpoint of giving a thermal insulating function, a sound insulating function or the like to the intermediate bonding layer. The other preferable condition is also the same as in the case of the laminated glass that does not have a cross section with a wedged shape.

Note that, among the intermediate bonding layers 13 and 14, the intermediate bonding layer arranged on the side contacting the wiring 16 (in the embodiment, the intermediate bonding layer 13) preferably does not contain a plasticizing agent. When the intermediate bonding layer does not contain a plasticizing agent, a metal configuring the wiring 16 can be prevented from being corroded and discolored by the plasticizing agent. However, depending on the intermediate bonding layer used, resistance to penetration of the laminated glass is enhanced and a performance requirement of a safety glass can be satisfied with the inclusion of a plasticizing agent. Thus, a presence or absence of a plasticizing agent may be selected according to the purpose.

The base film 15 is a support body for forming the wiring 16. For the base film 15, a film-like base film such as a polyethylene terephthalate, a polyethylene naphthalate, a polycarbonate, a polystyrene, or a cyclic polyolefin can be used. A thickness of the base film 15 may fall within a range of, for example, about 25 μm to 150 μm.

On one surface of the base film 15 (in the embodiment, on the side of the glass plate 11), the wiring 16 is formed. The wiring 16 generates heat when an electric current is supplied from a power source, such as a battery, via an electrode part (not shown). Heat generated by the wiring 16 is transferred to the glass plates 11 and 12, to warm up the glass plate 11 and 12. Fogging by dew condensation adhering to the glass plates 11 and 12 is removed, and thereby a favorable visual field for an occupant can be secured.

A material for the wiring 16 is not particularly limited if it is a conductive material. For example a metallic material can be used. The metallic material includes, for example, copper, aluminum, nickel, or tungsten. The wiring 16 may have a form, as illustrated in FIG. 1A, in which a plurality of arrays with shapes of sine waves are arranged at a predetermined interval, and are connected in series with each other. The form may be a shape of a mesh (mesh pattern) or may be another shape.

However, in the case of a mesh pattern with a sufficiently small mesh size, the intermediate bonding layer is heated uniformly when current is applied, and the extent of the optical distortion when current is applied is small in the first place. Thus, more remarkable effect is exhibited when a plurality of conductive thin wires extend without mutually crossing, i.e. separated from each other, as illustrated in FIG. 1A.

Note that the wiring 16 is not required to have a shape of wave, as illustrated in FIG. 1A, but may extend in polygonal line shapes, or may extend linearly.

A line width of the wiring 16 is preferably 5 μm or more and 30 μm or less. When the line width of the wiring 16 is greater than 5 μm, malfunctions such as wire disconnection are prevented. When the line width of the wiring 16 is less than 30 μm, it is difficult to visually identify the line. Moreover, the line width may be changed along the line.

The wiring 16 is not required to be arranged over the approximately entire main surface of the front windshield 10, as illustrated in FIG. 1A. The wiring 16 may be arranged within at least a partial region in the main surface of the front windshield 10. In this case, in a region where the wiring 16 is not arranged, the thickness of the intermediate bonding layer 13 and the thickness of the intermediate bonding layer 14 may be approximately same, and may be greater than or equal to 0.20 mm. The thicknesses being approximately same means that a difference in the thicknesses of about 10% is allowed. Moreover, the wiring 16 may be arranged on a vehicle internal surface of the base film 15, or may be arranged on a vehicle external surface of the base film 15.

Moreover, in a peripheral portion of the front windshield 10, a shielding layer 19 referred to as a so-called “black ceramic” is preferably present. The shielding layer 19 is formed by applying a black ceramic ink for printing on a glass surface and baking the same. According to the shielding layer 19, a black obscure layer is formed in the peripheral portion of the front windshield 10. According to the black obscure layer, a resin such as a urethane for holding the front windshield 10 in the peripheral portion can be prevented from being degraded by ultraviolet light.

Moreover, a coat having a water-repellant function, an ultraviolet light shielding function, an infrared light shielding function, or a visible light absorption function, or a coat having a low radiation characteristic may be arranged on the vehicle external surface or on the vehicle internal surface of the front windshield 10. Moreover, on surfaces of the glass plates 11 and 12 on the sides contacting the intermediate bonding layers 13 and 14, respectively, a coat having the ultraviolet light shielding function, the infrared light shielding function, the low radiation characteristic, the visible light absorption function, the coloring, or the like may be arranged.

In order to produce a front windshield 10, first, glass plates 11 and 12 are produced by using a floating method, for example. Moreover, a base film 15 is prepared, and a wiring 16 is formed on one surface of the base film 15. The wiring 16 can be formed on the one surface of the base film 15 using a well-known wiring forming method such as a subtractive method or a semi additive method.

Next, the intermediate bonding layers 13 and 14 are prepared, and a laminated body holding the base film 15, on which the wiring 16 is formed, at a predetermined position between the intermediate bonding layers 13 and 14 in between is produced. Then, the laminated body is further inserted between the glass plates 11 and 12, and thereby a laminated glass precursor (laminated glass before a pressure bonding), in which the respective members are laminated in an order illustrated in FIG. 1B, is produced. Note that materials and thicknesses of the respective members used in the aforementioned processes are described as above.

Next, the laminated glass precursor is put into a vacuum bag made of rubber or the like, the vacuum bag is connected to an exhaust system, and bonding is performed at a temperature of about 70° C. to 130° C., while performing a vacuum suction (degassing) so that a pressure inside the vacuum bag is reduced to an extent (reduction in absolute pressure) of about −65 kPa to −100 kPa. Thus, the laminated glass (front windshield 10, illustrated in FIGS. 1A and 1B) can be obtained.

Furthermore, by performing a pressure bonding process for pressurized heating with a condition of, for example, a temperature of 100° C. to 150° C. and a pressure of 0.1 MPa to 1.3 MPa, a laminated glass more excellent in durability can be obtained. However, in some cases, in order to simplify the manufacturing processes or taking into account a characteristic of the material encapsulated in the laminated glass, the pressure bonding process may be omitted.

Moreover, a bus bar is provided at an optional position of an end portion of the wiring 16, and a tape-like plain-woven fabric made of copper or a tape-like thin copper plate is arranged at the position in order to supply an electric power from outside the front windshield 10.

A thermal conductivity of the intermediate bonding layers 13 and 14 is about one fifth of a thermal conductivity of the glass plates 11 and 12. Moreover, a linear expansion coefficient of the intermediate bonding layers 13 and 14 is greater than a linear expansion coefficient of the glass plates 11 and 12 by about two orders of magnitude.

Thus, the change in a refractive index attributed to the intermediate bonding layers 13 and 14 is greater than the change in a refractive index attributed to the glass plates 11 and 12. Thus, when film thicknesses of the intermediate bonding layers 13 and 14 are great, heat is accumulated in the intermediate bonding layers 13 and 14, and due to the change in the refractive index, an optical distortion when current is applied occurs.

Then, when the film thickness of one of the intermediate bonding layers 13 and 14 is reduced, the wiring 16 that is a heat source becomes close to the glass plate 11 or 12, and heat near the wiring 16 is easily released to the outside of the glass plates 11 or 12. As a result, the change in the refractive index attributed to the intermediate bonding layers 13 and 14 is controlled and the optical distortion when current is applied can be reduced. A preferred numerical value range of the intermediate bonding layers 13 and 14 will be described in the practical example.

Note that in the case where the shape of the wiring 16 is a mesh configuration, because the number of lines is large, an amount of current (i.e. an amount of heat) per one line is small, and the temperature of the intermediate bonding layers 13 and 14 is inhibited from increasing. Thus, the effect of making one of the intermediate bonding layers 13 and 14 thinner than the other one is exhibited more remarkably in the case of the shapes of sine waves or the like, where the amount of current (i.e. amount of heat) per one line is relatively great, than in the case where the shape of the wiring 16 is a mesh configuration.

[Practical Example]

By using the aforementioned manufacturing method of a laminated glass, nine types of samples of the front windshield 10 were prepared, changing the thickness T₁ of the intermediate bonding layer 13 (on the side where the wiring 16 is formed) and the thickness T₂ of the intermediate bonding layer 14 (on the side where the wiring 16 is not formed). For the intermediate bonding layers 13 and 14, PVB was used. For the base film 15, a polyethylene terephthalate film with a thickness of 0.05 mm was used. Moreover, for the material of the wiring 16, copper was used, and the wiring 16 had a form in which a plurality of arrays with shapes of sine waves, with line widths of 13 μm, were arranged at an interval of 2.5 mm, and were connected in series with each other.

After the samples were prepared, the samples were arranged so as to face forward toward a screen, and a light source was arranged on a side of the sample opposite to the screen. Then, in the respective cases of energizing the wiring 16 (amount of heating of 730 W/m²) and non-energizing the wiring 16, the sample was irradiated with light emitted from the light source, and an image of the sample was projected on the screen.

Then, a ratio of the line width B of the wiring 16 at the energization (average value) to the line width A of the wiring 16 at the non-energization (average value), B/A, was defined as an index for evaluating an extent of the optical distortion when current is applied. The optical distortion when current is applied was evaluated as “excellent” where the ratio B/A was less than 1.2, “good” where the ratio B/A was greater than or equal to 1.2 and less than 1.3, “fair” where the ratio B/A was greater than or equal to 1.3 and less than 1.4, and “poor” where the ratio B/A was greater than 1.4. TABLE 1 shows results of evaluation.

Note that the ratio B/A of greater than 1.4 was determined to be “poor”, because a distortion to the extent that was not practically acceptable was found in a projection image with the ratio B/A of greater than 1.4.

TABLE 1

| | thickness T₁ of | thickness T₂ of | |
|---|---|---|---|
| | intermediate | intermediate | degree of |
| | bonding layer 13 | bonding layer 14 | optical |
| sample | [mm] | [mm] | distortion |
| 1 | 0.05 | 0.76 | excellent |
| 2 | 0.10 | | good |
| 3 | 0.20 | | fair |
| 4 | 0.38 | | poor |
| 5 | 0.05 | 2.28 | excellent |
| 6 | 0.05 | 0.38 | excellent |
| 7 | 0.38 | | poor |
| 8 | 0.76 | 0.05 | good |
| 9 | | 0.20 | fair |

It is found, from TABLE 1, that in order to control the optical distortion when current is applied, a thickness of one of the intermediate bonding layers 13 and 14 is required to be thinner than a thickness of the other one of the intermediate bonding layers, and the thickness of the thinner intermediate bonding layer is required to be 0.20 mm or less. Moreover, the thickness of the thinner intermediate bonding layer is preferably 0.10 mm or less, and more preferably 0.05 mm or less. This is because the effect of controlling the optical distortion when current is applied is enhanced, when the thickness of the intermediate bonding layer becomes thinner. However, the thickness of the thinner intermediate bonding layer is preferably 0.01 mm or more. This is because when the thickness of the thinner intermediate bonding layer is 0.01 mm or more, it becomes easy to handle in manufacturing.

Moreover, a ratio of thicknesses of a pair of intermediate bonding layers is preferably 1:7 or more.

Moreover, it is found that, from the comparison of Sample 1 with Sample 8, although the thinner intermediate bonding layer is preferably arranged on the side contacting the wiring 16, a certain effect can be obtained even when the thinner intermediate bonding layer is arranged on the side not contacting the wiring 16.

Moreover, if the thickness of the thinner intermediate bonding layer is 0.20 mm or less, the thickness of the thicker intermediate bonding layer is not restricted. However, the thickness of the thicker intermediate bonding layer is preferably 0.38 mm or more and 2.28 mm or less. When the thickness of the thicker intermediate bonding layer is 0.38 mm or more, a function of a safety glass is satisfied. When the thickness of the thicker intermediate bonding layer is 2.28 mm or less, restriction in mounting on a vehicle is reduced in terms of a weight or a thickness.

In this way, in order to control the optical distortion when current is applied, a thickness of one of the intermediate bonding layers 13 and 14 is required to be thinner than a thickness of the other one of the intermediate bonding layers, and the thickness of the thinner intermediate bonding layer is required to be 0.20 mm or less. Then, the thickness of the thinner intermediate bonding layer is preferably 0.01 mm or more, and the thickness of the other one of the intermediate bonding layers is preferably 0.38 mm or more and 2.28 mm or less.

On a surface of intermediate bonding layers, irregularities are typically formed in order to suppress a blocking phenomenon, improve work efficiency, and enhance a degassing property for a preliminary pressure bonding. When the press bonding of the glass plates with the intermediate bonding layer is performed, irregularities contacting the glass plate disappear. However, an optical distortion of reflected light having a fluctuation referred to as a so-called orange peel effect (or also referred to as apple sauce) conventionally occurs.

In the case where the thickness of the intermediate bonding layer 13 is thinner than the thickness of the intermediate bonding layer 14, by making the thickness of the thinner intermediate bonding layer 13 0.20 mm or less, preferably 0.10 mm or less, and more preferably 0.05 mm or less, a pressure from the glass plate 11 is transferred uniformly to the base film 15 easily, when the press bonding of the glass plate 11 with the intermediate bonding layer 13 is performed. Thus, optical distortion of reflected light arising from the deformation of the base film 15 is controlled.

As described above, the preferred embodiments and the like have been described in detail. However, the present invention is not limited to the above-described specific embodiments, and various variations and modifications may be made without deviating from the scope of the present invention.

The present application is based on and claims the benefit of priority of Japanese Priority Application No. 2016-158857 filed on Aug. 12, 2016, the entire contents of which are hereby incorporated by reference.

### REFERENCE SIGNS LIST

10 front windshield
11,12 glass plate
13,14 intermediate bonding layer
15 base film
16 wiring

What is claimed is:

1. A laminated glass comprising:
a pair of glass plates opposite each other;
a pair of intermediate bonding layers located between the pair of glass plates, each of the intermediate bonding layers contacting a corresponding glass plate of the glass plates; and
a base film located between the pair of intermediate bonding layers, and being provided with a wiring in at least a partial area of the base film,
wherein a thickness of one of the intermediate bonding layers is thinner than a thickness of another one of the intermediate bonding layers, and
wherein a thickness of a thinner intermediate bonding layer of the pair of intermediate bonding layers is 0.20 mm or less.

2. The laminated glass according to claim 1,
wherein a thickness of a thicker intermediate bonding layer of the pair of intermediate bonding layers is 0.38 mm or more and 2.28 mm or less.

3. The laminated glass according to claim 1,
wherein a ratio of thicknesses of the pair of the intermediate bonding layers is 1:7 or more.

4. The laminated glass according to claim 1,
wherein the thinner intermediate bonding layer is arranged on a side contacting the wiring, and
wherein the thicker intermediate bonding layer is arranged on a side not contacting the wiring.

5. The laminated glass according to claim 1,
wherein thicknesses of the pair of intermediate bonding layers are approximately same in a region where the wiring does not exist.

6. The laminated glass according to claim 1,
wherein, among the pair of intermediate bonding layers, at least an intermediate bonding layer arranged on a side contacting the wiring does not contain a plasticizing agent.

7. The laminated glass according to claim 1,
wherein a line width of the wiring falls within a range from 5 μm to 30 μm.

8. The laminated glass according to claim 1,
wherein a pattern of the wiring includes a plurality of thin wires arrayed in one direction, and
wherein the plurality of thin wires are separated from each other and extend without mutually crossing.

9. The laminated glass according to claim 1,
wherein a thickness of at least any one of the pair of glass plates is less than 1.8 mm.
